(19) United States
(12) Patent Application Publication
(10) Pub. No.: US 2009/0020374 A1
(43) Pub. Date: Jan. 22, 2009

(54) Buggy Cart Brake System

(76) Inventor: Casey L. Littles, Seneca, NC (US)

Correspondence Address: CLOUTIER & ENGLE, PLLC;ATTN: PRIYA SINHA CLOUTIER, 320 DAYTON STREET, SUITE 260, EDMONDS, WA, 98020, US

(21) Appl. No.: 11/778,828

(22) Filed: Jul. 17, 2007

(51) Int. Cl. F16D 55/22

(52) U.S. Cl. 188/72.3

(57) ABSTRACT

A grocery cart braking system is described having a brake release bail bar assembly, a clutch disk assembly, a replaceable sacrificial brake shoe, and a biased brake rod assembly. The clutch disk assembly may be a single disk or a two part disk assembly. The two part disk assembly allows adjustment of the bail bar relative to the biased brake rod assembly. Mechanical advantage may be achieved with the clutch disk assembly allowing greater or lesser braking force for the same actuation force of the bail bar. Braking bias force may be adjusted by positional adjustment of the spring cage or the spring retaining means. The braking system may be applied to one or more cart wheels, preferably two wheels.

### CROSS-REFERENCES TO RELATED APPLICATIONS

Not Applicable

### STATEMENT REGARDING FEDERALLY SPONSORED RESEARCH OR DEVELOPMENT

Not Applicable

### INCORPORATION-BY-REFERENCE OF MATERIAL SUBMITTED ON A COMPACT DISC

Not Applicable

### BACKGROUND OF THE INVENTION

The invention relates to a braking system for manually propelled carts such as a grocery shopping cart. More particularly, the braking system provides braking force to the wheel or wheels of said carts that may be momentarily deactivated by actuation of a braking handle by the cart user. Releasing the braking handle reactivates the braking force applied to the cart wheel or wheels.

Convention carts, such as grocery carts, may be hazardous without a braking system and frequently damage vehicles in parking lots by rolling into them or may injure people in a similar manner. These hazards become more significant with increased steepness of grade or loading of the cart. Prior art cart braking systems can be mechanically complex, difficult to operate, expensive or complex to apply to an existing cart inventory, may actually damage other cart structures including the braked wheel itself, or may be difficult to maintain and adjust throughout the life of the cart and braking system. Additionally, not all prior art braking systems brake in both a forward and reverse direction.

### BRIEF SUMMARY OF THE INVENTION

The braking system of the current invention is mechanically simple, may be applied to many existing cart inventories with relatively moderate modification of the carts and at moderate cost, employs a replaceable sacrificial braking shoe to minimize the chance of damage to the other cart structures with which the braking system interacts, and can be quickly adjusted with simple tools to facilitate maintenance of the braking systems efficacy as parts age or become worn. Further, the current invention applies a braking force in both a forward and reverse cart movement direction.

Generally the braking system of the present invention includes a sacrificial brake shoe replaceably connected to a biased brake rod assembly, said bias creating a frictional braking force between the sacrificial brake shoe and a wheel of a cart. The bias of the biased brake rod assembly may be overcome, reducing or removing said frictional braking force, by actuation of a brake release bail bar assembly interconnected with the biased brake rod assembly through a rotational clutch assembly. Release of the brake release bail bar assembly removes the forces overcoming the bias of the biased brake rod assembly and the sacrificial brake shoe will reengage the cart wheel and reapply said frictional braking force. This frictional braking force is independent of the rotational direction of the wheel and will result in braking in both the forward and reverse operational direction of a cart wheel.

While typically the two rear wheels of a cart will be simultaneously braked by use of two biased brake rod assemblies connected to the brake release bail bar assembly through two corresponding rotational clutch assemblies, one of ordinary skill in the art will clearly appreciate braking fewer or additional cart wheels by simple modification of the preferred embodiment of the present invention. These configurations of fewer or additional braked wheels are considered to be part of the present invention thought for clarity they will not be herein her described.

### BRIEF DESCRIPTION OF THE SEVERAL VIEWS OF THE DRAWINGS

FIG. 1 is a side elevation view of the brake system employed in conjunction with a typical grocery shopping cart.

FIG. 2 is a rear elevation view of the brake system employed in conjunction with a typical grocery shopping cart.

FIG. 3 is a front and side plan view of the brake release bail bar of the present invention.

FIG. 4 is a front plan view of the biased brake rod of the present invention.

FIG. 5 is an isometric view of additional components of brake system.

FIGS. 6A, 6B, 6C, 6D are schematic drawings of embodiments of the rotational clutch assembly of the present invention.

### DETAILED DESCRIPTION OF THE INVENTION

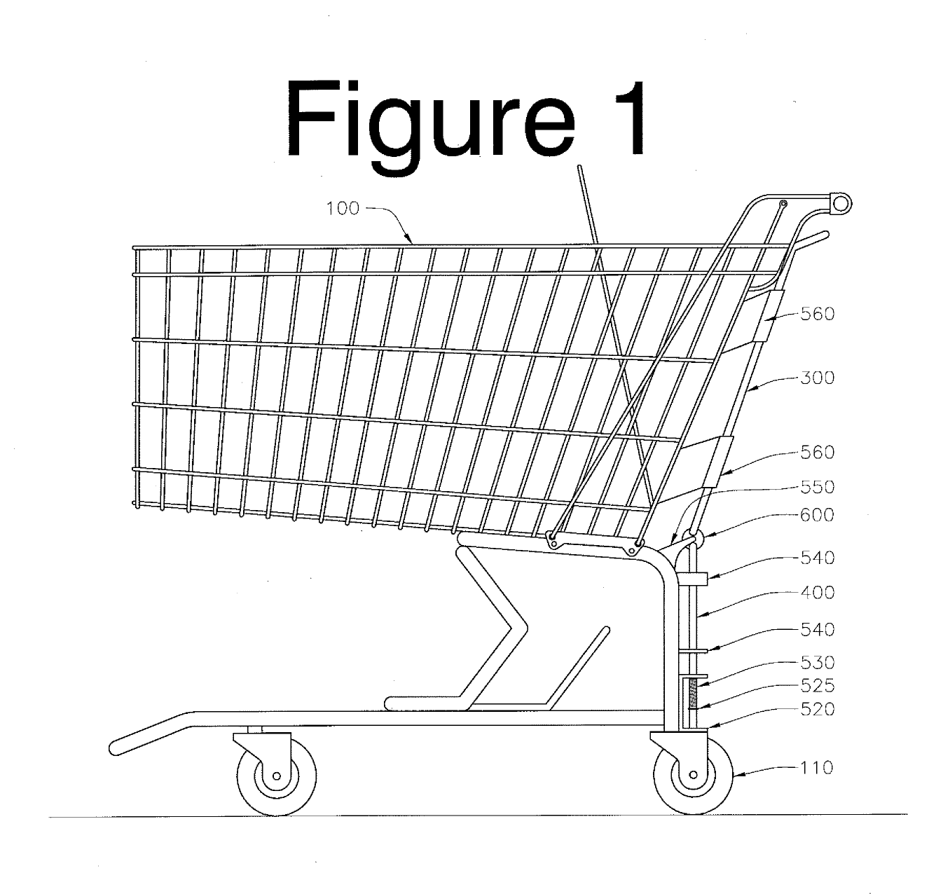

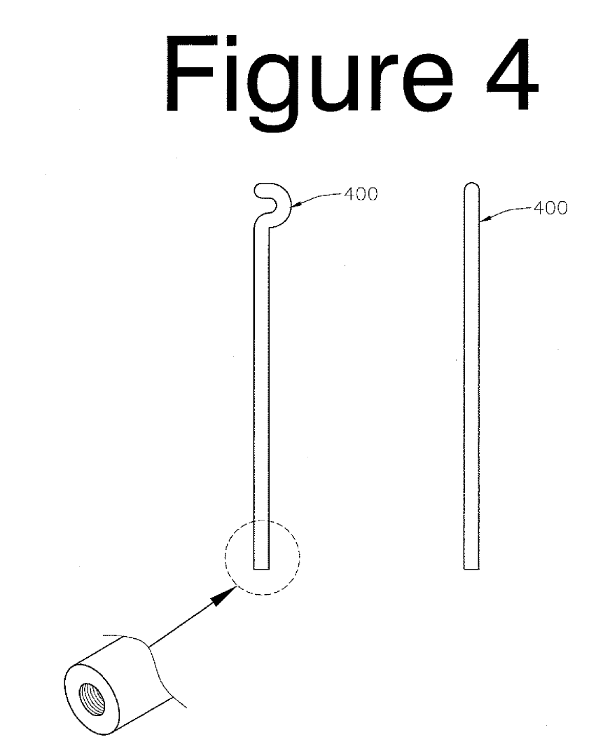

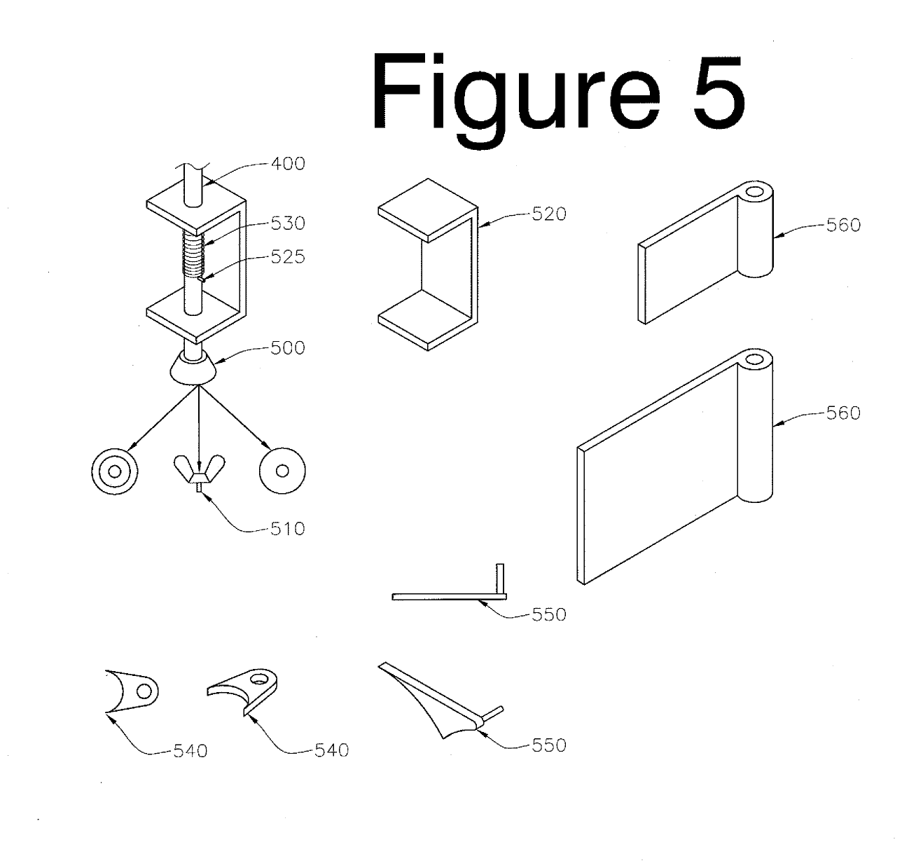

Referring to FIG. 1, the present invention is shown integrated into a typical commercial grocery shopping cart 100. Braking force is applied to at least one wheel 110 by a biased downward pressure of the biased brake rod assembly comprising a sacrificial brake shoe 500 (view obscured in FIG. 1, see FIG. 5), removably connected to a biased brake rod 400 (as shown in FIG. 4) by a removable fastener 510 (view obscured in FIG. 1, see FIG. 5), receiving biasing pressure from a biasing spring 530 (also shown in FIG. 5) held between a biasing spring bracket 520 (also shown in FIG. 5) and a bias spring tensioning means 525 (also shown in FIG. 5) adjustably connected to the biased brake rod 400, the biased brake rod assembly supported by one or more guide brackets 540 (also shown in FIG. 5).

In the preferred embodiment of the present invention, the guide brackets 540 and biasing spring bracket 520 are statically connected to the cart 100 allowing the biased brake rod 400 to slide there through and apply or remove braking force applied by the removably connected sacrificial brake shoe 500 to the wheel 110. In an alternate embodiment, the static position of the biasing spring bracket 520 may be adjustable, for example by being slidably mounted to the cart 100 frame and retained in a particular static position thereafter with screws or bolts, to allow adjustment of the static position and correspondingly to allow adjustment of the tension of the biasing spring 530. Moreover, tension of the biasing spring in these and other embodiments may be adjusted by adjusting the position of the bias spring tensioning means 525 along the axis of the biased brake rod 400. The bias spring tensioning means 525 may for example be a spring clip, a collar and set screw, or a pin inserted transverse to the axis of the biased brake rod 400, among others.

Biasing of the biased brake rod 400 by the biasing spring 530 may be by either compression or extension of a material with a spring force, most typically a coil spring. Compression force may be used to bias the brake by positioning the spring 530 between the top inner retention face of the spring bracket 520 and the bias spring tensioning means 525 such that the spring “pushes” the biased brake rod 400 against the wheel 110. Alternatively, expansion force may be used by attaching the spring 530 to the lower inner retention face of the spring bracket 520 and the bias spring tensioning means 525 such that as the spring retracts form an expanded condition it “pulls” the biased brake rod 400 against the wheel 110.

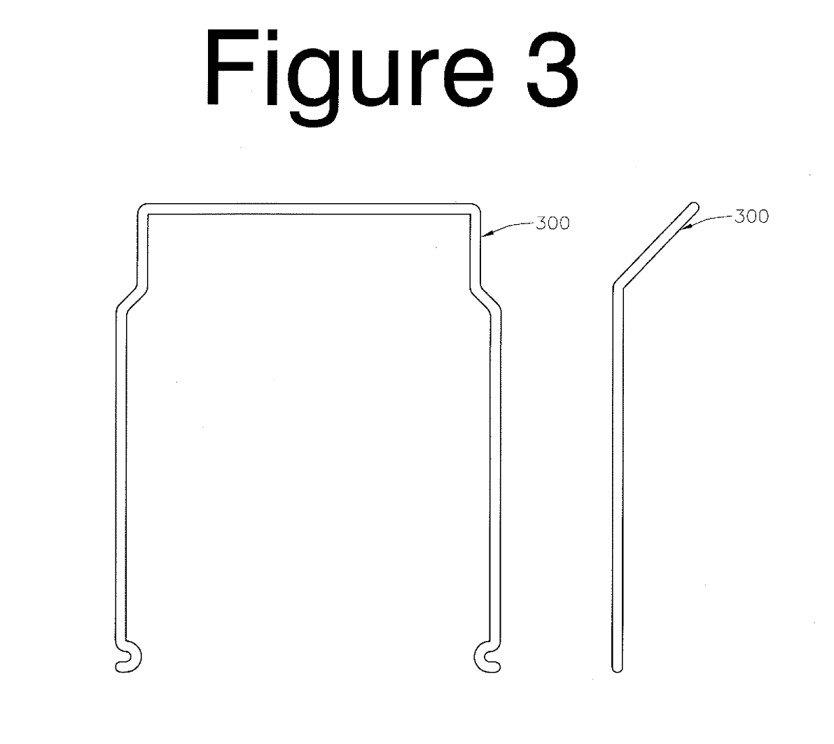

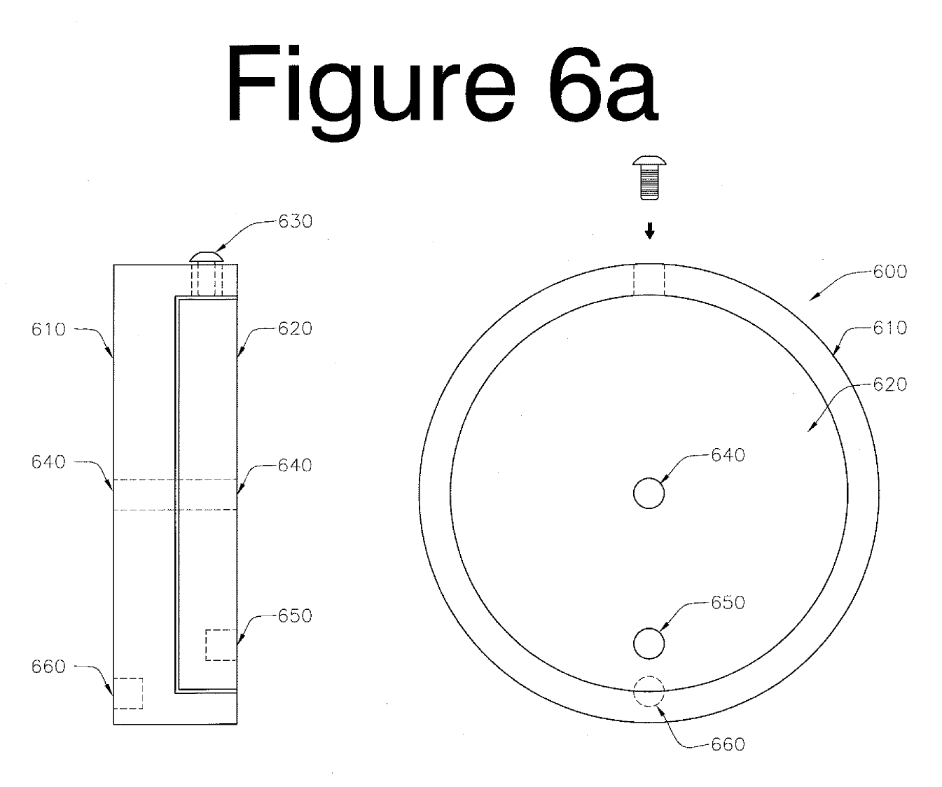

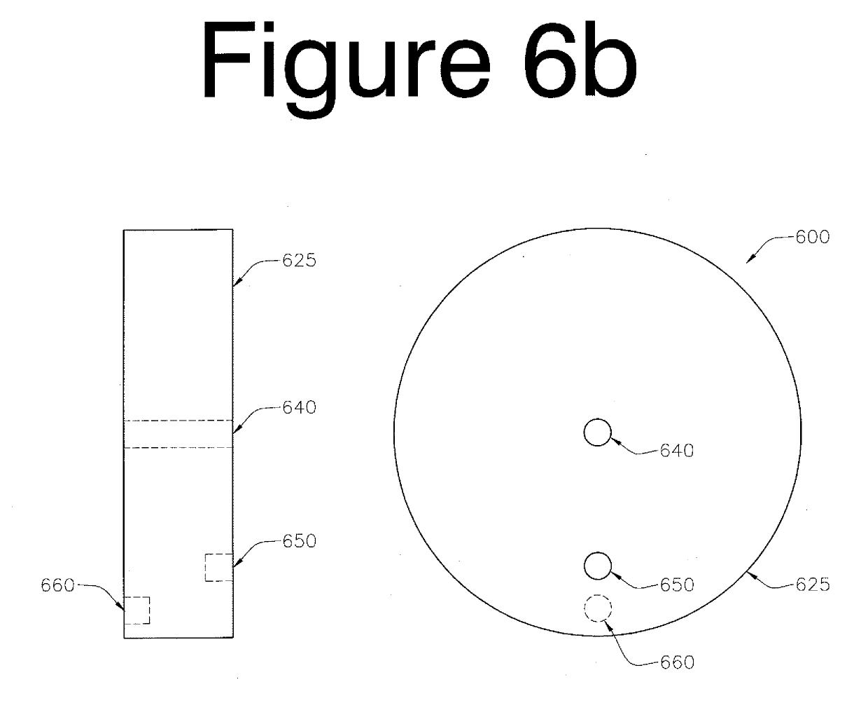

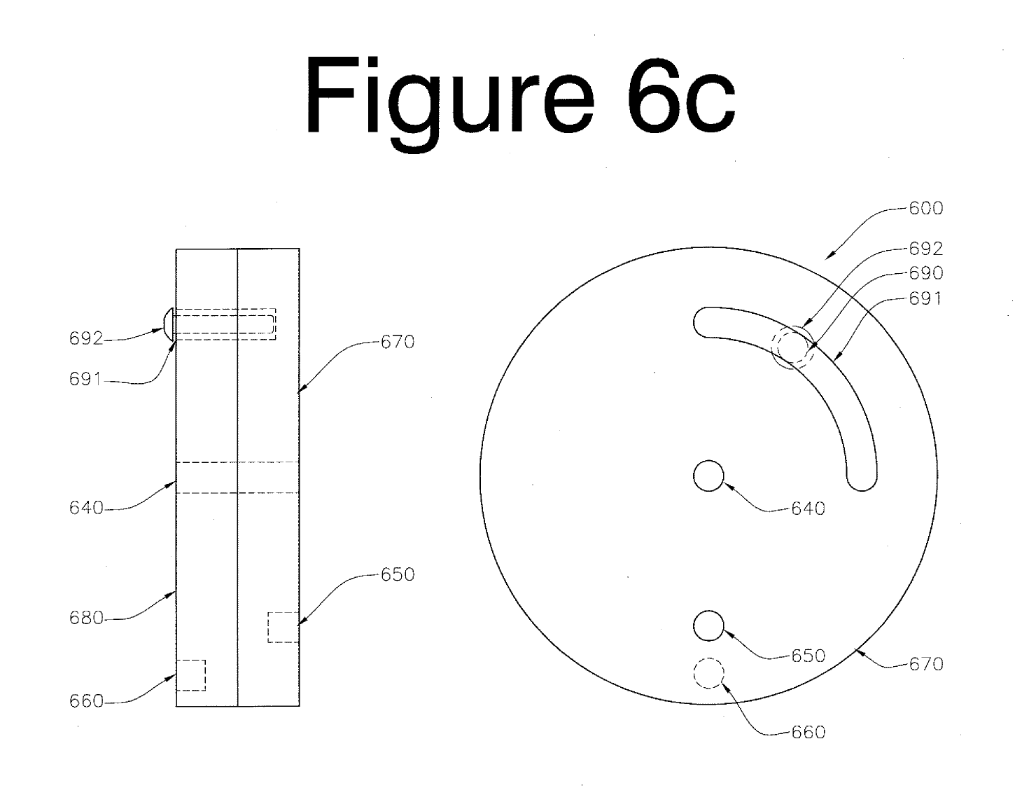

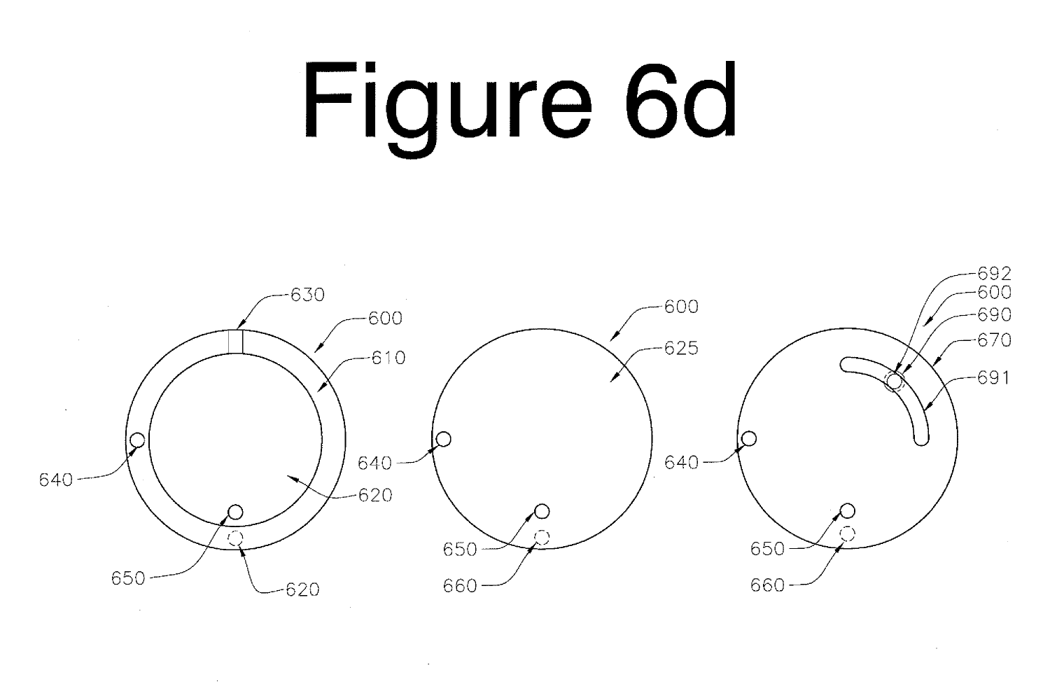

Still referring to FIG. 1, braking force can be diminished or removed by actuating a brake release bail bar assembly comprising a brake release bail bar 300 and one or more guide brackets 560 (also shown in FIG. 5), communicatively interconnected with the biased brake rod assembly (see above) through a rotational clutch assembly comprising one or more clutch disks 600 (see FIG. 6A, 6B, or 6C) removably attached to a clutch disk guide 550 (also shown in FIG. 5). Actuating the brake release bail bar assembly rotates the clutch disks 600 about the clutch disk guide 550, converting the linear motion of the brake release bail bar 300 (as shown in FIG. 3) into rotary motion in the clutch disks 600. Rotary motion of the clutch disk is converted to linear motion of the biased brake rod 400.

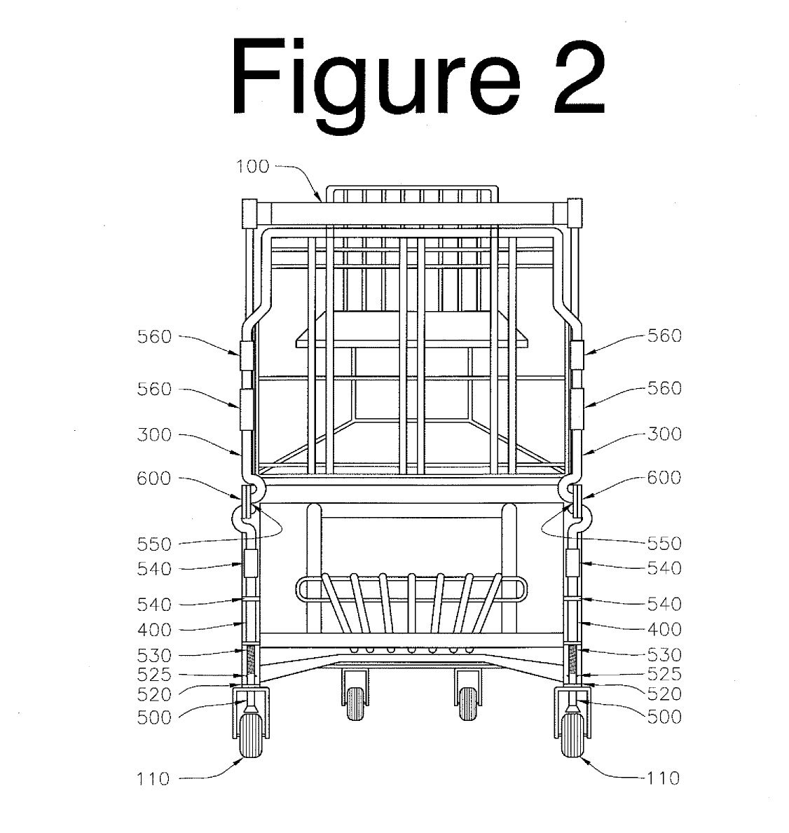

As seen in FIG. 2, the preferred embodiment of the present invention applies braking force to two cart wheels 110. However, fewer or additional wheels may be braked by minor modifications of the braking system. Braking of fewer or additional wheels by these minor modifications is considered to be part of the scope of the present invention and is not discussed further herein for clarity and brevity.

One embodiment of the clutch disks 600 is illustrated in FIG. 6A, wherein an inner disk 620 is retained in an outer cup shaped disk 610 in a manner that allows the inner disk 620 to rotate freely within the outer cup shaped disk 610. The relative rotational positions of the inner disk 620 and the outer cup shaped disk 610 may be held static by use of one or more set screws 630. Both the inner disk 620 and the outer cup shaped disk 610, once held static to each other by the set screws, preferably rotate at a centralized axis of rotation 640 where they are supported by the clutch disk guide 550.

An alternative embodiment of the clutch disks 600 is illustrated in FIG. 6C, wherein a proximal disk 670 and distal disk 680 may be positioned by rotating about a central axis, the relative rotational position of the two disks then being held static by one or more set screws 692 extending through a slot 691 in one disk and threading into a tapped hole 690 in the other disk. Both the proximal disk 670 and distal disk 680, once held static to each other by the set screws, preferably rotate at a centralized axis of rotation 640 where they are supported by the clutch disk guide 550.

As seen in FIG. 6B, a unitary clutch disk 625 may be employed as an alternative embodiment of the clutch disks 600. The unitary clutch disk 625 is a single disk having an axis of rotation 640, a brake release bail bar pivot cup 660, and a biased brake rod pivot cup 650, but being of only a single disk, not having any set screws or ability to adjust the relative rotational angles between the brake release bail bar pivot cup 660 and the biased brake rod pivot cup 650.

As seen in FIG. 6D, alternative embodiments may employ an off-center axis of rotation 640 removably supported by the clutch disk guide 550 provided that either 1) the rotation of the inner disk 620 and the outer cup shaped disk 610 relative to each other is not impaired before engaging the one or more set screws 630, 2) the rotation of the proximal disk 670 and distal disk 680 relative to each other is not impaired before engaging the one or more set screws 692, or 3) the unitary clutch disk 625 is employed.

The relative positions of the biased brake rod pivot cup 650 and brake release bail bar pivot cup 660 achieved by allowing the selectable positions of either the inner disk 620 and the outer cup shaped disk 610 as in FIG. 6A or the proximal disk 670 and distal disk 680 as in FIG. 6C allows adjustment of the position of the brake release bail bar 300 (angular adjustment not available using the unitary clutch disk 625.) For example, as the sacrificial brake pad 500 wears with use, the brake release bail bar 300 will become more and more extended from the shopping cart handle; then by loosening the set screws 630 or 692, adjusting the relative positions of the clutch disks 610 and 620 or 670 and 680, and retightening the set screws 630 or 692, the brake release bail bar 300 can be raised to a comfortable position relative to the sopping cart handle.

Again referring to FIG. 6A, the radial distance from the centralized axis of rotation 640 (or off-center axis of rotation 640 as in FIG. 6D) of the pivot cups 650 and 660 may allow mechanical advantage in overcoming the braking bias force resulting from the bias spring 530 (see FIG. 1). By positioning the brake release bail bar pivot cup 660 at a greater radial distance from the axis of rotation 640 than the biased brake rod pivot cup 650 less force is required at the brake release bail bar 300 to overcome the braking bias and release the sacrificial brake pad 500 from the cart wheel 110. Similarly, by positioning the brake release bail bar pivot cup 660 at a lesser radial distance from the axis of rotation 640 than the biased brake rod pivot cup 650 more force is required at the brake release bail bar 300 to overcome the braking bias and release the sacrificial brake pad 500 from the cart wheel 110. Also, by positioning the brake release bail bar pivot cup 660 and the biased brake rod pivot cup 650 at an equal radial distance from the axis of rotation 640 no additional mechanical advantage is achieved. Depending on particular customer needs, clutch disks as described above may be selected to provide the desired mechanical advantage and adjustability.

While the present invention has been described in connection with what is considered the most practical and preferred embodiment, it is understood that this invention is not limited to the disclosed embodiments but is intended to cover various arrangements included within the spirit and scope of the broadest interpretation so as to encompass all such modifications and equivalent arrangements.

The invention claimed is:

1. A braking mechanism comprising:
a replaceable sacrificial brake shoe for imparting a braking force;
said replaceable sacrificial brake shoe being removably connected to the distal end of a biased brake rod assembly further comprising—
a biased brake rod bar;
one or more supporting brackets; and
a means of biasing the brake rod bar to provide the braking force;
the proximal end of said biased brake rod assembly being communicatively interconnected to a rotational clutch assembly further comprising—
a clutch disk having a pivot point; and
said pivot point removably and rotationally engaging a clutch disk supporting bracket; and
said clutch disk assembly being also communicatively interconnected to the distal end of a brake release bail bar assembly further comprising—
a brake release bail bar; and
one or more supporting brackets.

2. The braking mechanism of claim 1 wherein:
the clutch disk pivot point is a through hole;
the clutch disk supporting bracket has an axle; and
the clutch disk is removably and rotationally engaged at the through hole pivot point on the clutch disk supporting bracket axle.

3. The braking mechanism of claim 1 wherein:
the clutch disk pivot point is an axle;
the clutch disk supporting bracket has a mounting point for an axle; and
the clutch disk is removably and rotationally engaged by the axle to said axle mounting point of the clutch disk supporting bracket.

4. The braking mechanism of claim 1 wherein the clutch disk is a monolithic unitary clutch disk having a pivot point for pivoting said monolithic unitary clutch disk and further comprising:
a brake rod assembly pivot point for communicatively interconnecting to the proximal end of said brake rod assembly; and
a brake release bail bar assembly pivot point for communicatively interconnecting to the distal end of said brake release bail bar assembly.

5. The braking mechanism of claim 1 wherein the clutch disk is a two piece clutch disk having a pivot point for pivoting said two piece clutch disk and further comprising:
a first clutch disk piece having a smaller outer diameter than a second clutch disk piece and being rotationally nested inside a depression in said second clutch disk piece such that said first and second clutch disk pieces share a center of rotation, said first clutch disk piece also having a brake rod assembly pivot point for communicatively interconnecting to the proximal end of said brake rod assembly;
said second clutch disk piece having a larger outer diameter than said first clutch disk piece and having therein the depression in which said first clutch disk piece may be being rotationally nested such that said first and second clutch disk pieces share said center of rotation, said second clutch disk piece also having a brake release bail bar assembly pivot point for communicatively interconnecting to the distal end of said brake release bail bar assembly; and
at least one releasable set screw through the outer diameter and inner depression wall of said second clutch disk piece pressing against the outer diameter of said first clutch disk piece for holding the rotational angle between said second clutch disk piece and said first clutch disk piece around said shared center of rotation static at a selectable rotational angle.

6. The braking mechanism of claim 1 wherein the clutch disk is a two piece clutch disk having a pivot point for pivoting said two piece clutch disk and further comprising:
a first clutch disk piece having at least one threaded hole for releasably engaging at least one set screw passing through at least one curved slot in a second clutch disk piece, each slot being at a constant radial distance from a common center of rotation between said first clutch disk piece and said second clutch disk piece, such that the rotational angle between said first and second clutch disk pieces around said shared center of rotation may be held static at a selectable rotational angle by employing a set screw;
said first clutch disk piece also having a brake rod assembly pivot point for communicatively interconnecting to the proximal end of said brake rod assembly;
said second clutch disk piece also having a brake release bail bar assembly pivot point for communicatively interconnecting to the distal end of said brake release bail bar assembly; and
at least one releasable set screw through said at least one curved slot in the wall of said second clutch disk piece and into said at least one threaded hole of said first clutch disk piece for holding the rotational angle between said second clutch disk piece and said first clutch disk piece around said shared rotational axis static at a selectable rotational angle.

7. The braking mechanism of claim 1 wherein said clutch disk further comprises:
a brake rod assembly pivot point for communicatively interconnecting to the proximal end of said brake rod assembly;
a brake release bail bar assembly pivot point for communicatively interconnecting to the distal end of said brake release bail bar assembly; and
the radial distance from the center of said clutch disk of said brake rod assembly pivot point is greater than the radial distance from the center of said clutch disk of said brake release bail bar assembly pivot point.

8. The braking mechanism of claim 1 wherein said clutch disk further comprises:
a brake rod assembly pivot point for communicatively interconnecting to the proximal end of said brake rod assembly;
a brake release bail bar assembly pivot point for communicatively interconnecting to the distal end of said brake release bail bar assembly; and
the radial distance from the center of said clutch disk of said brake rod assembly pivot point is equal to the radial distance from the center of said clutch disk of said brake release bail bar assembly pivot point.

9. The braking mechanism of claim 1 wherein said clutch disk further comprises:
a brake rod assembly pivot point for communicatively interconnecting to the proximal end of said brake rod assembly;
a brake release bail bar assembly pivot point for communicatively interconnecting to the distal end of said brake release bail bar assembly; and
the radial distance from the center of said clutch disk of said brake rod assembly pivot point is less than the radial distance from the center of said clutch disk of said brake release bail bar assembly pivot point.

10. An automatically braked cart comprising:
a cart body;
a plurality of cart roller wheels coupled to, and supporting, said cart body such that the cart body may be moved by rotation of said cart roller wheels; and
a braking mechanism including—
a replaceable sacrificial brake shoe for imparting a braking force;
said replaceable sacrificial brake shoe being removably connected to the distal end of a biased brake rod assembly further comprising—
a biased brake rod bar;
one or more supporting brackets; and
a means of biasing the brake rod bar to provide the braking force;
the proximal end of said biased brake rod assembly being communicatively interconnected to a rotational clutch assembly further comprising—
a clutch disk having a pivot point; and
said pivot point removably and rotationally engaging a clutch disk supporting bracket; and
said clutch disk assembly being also communicatively interconnected to the distal end of a brake release bail bar assembly further comprising—
a brake release bail bar; and
one or more supporting brackets.

11. The automatically braked cart of claim claim 10 wherein:
the clutch disk pivot point is a through hole;
the clutch disk supporting bracket has an axle; and
the clutch disk is removably and rotationally engaged at the through hole pivot point on the clutch disk supporting bracket axle.

12. The automatically braked cart of claim claim 10 wherein:
the clutch disk pivot point is an axle;
the clutch disk supporting bracket has a mounting point for an axle; and
the clutch disk is removably and rotationally engaged by the axle to said axle mounting point of the clutch disk supporting bracket.

13. The automatically braked cart of claim claim 10 wherein the clutch disk is a monolithic unitary clutch disk having a pivot point for pivoting said monolithic unitary clutch disk and further comprising:
a brake rod assembly pivot point for communicatively interconnecting to the proximal end of said brake rod assembly; and
a brake release bail bar assembly pivot point for communicatively interconnecting to the distal end of said brake release bail bar assembly.

14. The automatically braked cart of claim claim 10 wherein the clutch disk is a two piece clutch disk having a pivot point for pivoting said two piece clutch disk and further comprising:
a first clutch disk piece having a smaller outer diameter than a second clutch disk piece and being rotationally nested inside a depression in said second clutch disk piece such that said first and second clutch disk pieces share a center of rotation, said first clutch disk piece also having a brake rod assembly pivot point for communicatively interconnecting to the proximal end of said brake rod assembly;
said second clutch disk piece having a larger outer diameter than said first clutch disk piece and having therein the depression in which said first clutch disk piece may be being rotationally nested such that said first and second clutch disk pieces share said center of rotation, said second clutch disk piece also having a brake release bail bar assembly pivot point for communicatively interconnecting to the distal end of said brake release bail bar assembly; and
at least one releasable set screw through the outer diameter and inner depression wall of said second clutch disk piece pressing against the outer diameter of said first clutch disk piece for holding the rotational angle between said second clutch disk piece and said first clutch disk piece around said shared center of rotation static at a selectable rotational angle.

15. The automatically braked cart of claim claim 10 wherein the clutch disk is a two piece clutch disk having a pivot point for pivoting said two piece clutch disk and further comprising:
a first clutch disk piece having at least one threaded hole for releasably engaging at least one set screw passing through at least one curved slot in a second clutch disk piece, each slot being at a constant radial distance from a common center of rotation between said first clutch disk piece and said second clutch disk piece, such that the rotational angle between said first and second clutch disk pieces around said shared center of rotation may be held static at a selectable rotational angle by employing a set screw;
said first clutch disk piece also having a brake rod assembly pivot point for communicatively interconnecting to the proximal end of said brake rod assembly;
said second clutch disk piece also having a brake release bail bar assembly pivot point for communicatively interconnecting to the distal end of said brake release bail bar assembly; and
at least one releasable set screw through said at least one curved slot in the wall of said second clutch disk piece and into said at least one threaded hole of said first clutch disk piece for holding the rotational angle between said second clutch disk piece and said first clutch disk piece around said shared rotational axis static at a selectable rotational angle.

16. The automatically braked cart of claim claim 10 wherein said clutch disk further comprises:
a brake rod assembly pivot point for communicatively interconnecting to the proximal end of said brake rod assembly;
a brake release bail bar assembly pivot point for communicatively interconnecting to the distal end of said brake release bail bar assembly; and
the radial distance from the center of said clutch disk of said brake rod assembly pivot point is greater than the radial distance from the center of said clutch disk of said brake release bail bar assembly pivot point.

17. The automatically braked cart of claim claim 10 wherein said clutch disk further comprises:
a brake rod assembly pivot point for communicatively interconnecting to the proximal end of said brake rod assembly;
a brake release bail bar assembly pivot point for communicatively interconnecting to the distal end of said brake release bail bar assembly; and
the radial distance from the center of said clutch disk of said brake rod assembly pivot point is equal to the radial distance from the center of said clutch disk of said brake release bail bar assembly pivot point.

18. The automatically braked cart of claim claim 10 wherein said clutch disk further comprises:
a brake rod assembly pivot point for communicatively interconnecting to the proximal end of said brake rod assembly;
a brake release bail bar assembly pivot point for communicatively interconnecting to the distal end of said brake release bail bar assembly; and
the radial distance from the center of said clutch disk of said brake rod assembly pivot point is less than the radial distance from the center of said clutch disk of said brake release bail bar assembly pivot point.
